(19) United States
(12) Patent Application Publication
(10) Pub. No.: US 2005/0120819 A1
(43) Pub. Date: Jun. 9, 2005

(54) Oscillating actuator

(75) Inventor: Daisaku Kawada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD, Tokyo (JP)

(21) Appl. No.: 10/504,026

(22) PCT Filed: Dec. 20, 2002
(86) PCT No.: PCT/JP02/13382

(30) Foreign Application Priority Data
Feb. 7, 2002 (JP) 2002-031248

(51) Int. Cl. B60K 17/04

(52) U.S. Cl. 74/473.12

(57) ABSTRACT

A swinging actuator has an output shaft rotatably supported by a support member, a driving source for rotate-driving the output shaft, and an output arm, whose base end portion is connected and fixed to an end surface of the output shaft. A portion to be driven is driven by the end portion of the output arm. The swinging actuator comprises a screw hole provided in a portion, which is positioned off the center of rotation of the output shaft, a through hole formed in the base end portion of the output arm, a connecting screw screwed into the screw hole in a state in which the connecting screw is inserted into the through hole, and an engagement portion provided between a part, which is positioned off the through hole and in the end portion of the output arm, and a part, which is off the screw hole and in the end surface of the output shaft.

### TECHNICAL FIELD

The present invention relates to a selecting actuator, which is incorporated into, for example, an electric drive apparatus for a transmission, for displacing a shift shaft for a gear unit in an axial direction.

### BACKGROUND ART

A manual transmission is used as an automotive transmission. However, in recent years, there have been proposed various kinds of automotive transmissions each for automatically switching a gear unit and for automatically disconnection of a clutch. International Publication No. WO01/31234A1 discloses an electric drive apparatus for changing gears constituting a gear unit in such an automotive transmission. Hereinafter, the electric drive apparatus for a transmission according to the International Publication is described by referring to FIGS. 6 to 8.

A mission case 1 is a case that incorporates a gear unit similar to a manual transmission. A tip end portion 3 of a shift shaft 2 for changing a gear ratio of this gear unit projects from a side surface of the mission case 1. A male spline portion 4 is formed in a middle part of this tip end portion 3. The male spline portion 4 is spline-engaged with a spline tube 5, on the inner surface of which a female spline is formed. An engagement piece 7, in the outer peripheral surface of which an engagement groove 11 is formed, is connected to a part that is closer to the tip of the tip end portion 3 protruding from the spline tube 5.

The operation shift shaft 2 is displaced in an axial direction (a front-rear direction of the sheet of FIG. 6, an up-down direction of the sheet of FIG. 7) in a selecting operation, and rotates in a shift operation. Incidentally, the selecting operation is an operation of displacing a shift lever in a direction of width of a vehicle in an ordinary manual floor shift car to thereby select a gear for changing a speed. On the other hand, the shifting operation is another operation of displacing the shift lever in a front-back direction of the vehicle to thereby connect a synchromesh mechanism corresponding to the selected gear.

Hereinafter, the selecting operation and the shifting operation are described in detail. A gear unit realizing six kinds of transmission states, which are five forward ones (first to fifth speed levels) and a rearward one (R), as shown in FIG. 9, are considered herein.

In the selecting operation, one of three kinds of positions, which are both lateral end positions and a laterally central position shown in FIG. 9, is selected. In this selecting operation, the synchromesh mechanisms are maintained in a free state. Thus, a neutral state is maintained, so that no speed change state occurs. In the shifting operation, the shift lever is displaced from one of the three kinds of positions in the neutral state in one direction (an upward or downward direction shown in FIG. 9). Consequently, one of the synchromesh mechanisms is brought into a connected state, so that one of speed change states occurs. Incidentally, according to the International Publication No. WO01/31234A1, a selecting actuator 8, which is a swinging actuator, is provided between an outer surface of the mission case 1 and the engagement piece 7 so as to displace the shift shaft 2 in the axial direction in the selecting operation.

As shown in FIG. 8, the selecting actuator 8 has a selecting electric motor 9, and a multiple thread worm gear 10 rotate-driven by an output shaft of the selecting electric motor 9. The multiple thread worm gear 10 meshes with a worm wheel 11. An output shaft 12 serving as the center of rotation of the worm wheel 11 is connected and fixed to a base end portion of a swinging arm 13. The swinging arm 13 rotates together with the worm wheel 11. An engagement convex portion 14 formed on one side surface of the tip end portion (the top surface of the left end portion, as viewed in FIG. 6) of the swinging arm 13 engages with the engagement groove 6 to thereby allow the shift shaft 2 to be displaceable.

On the other hand, a shifting actuator 16 serving as a direct acting actuator for rotating the shift shaft 2 is provided between an outer surface of the mission case 1 and a tip end portion of a driving arm 15 fixedly provided on an outer peripheral surface of the spline tube 5. The shifting actuator 16 has a casing 17 supported in such a way as to be swingably displaceable with respect to the mission case 1. A shifting motor, which is supported by and fixed to the casing 17 and can rotate forwardly and reversely, pushes and pulls the output shaft 18 in an axial direction through a ball screw mechanism provided in the casing 17.

The electric drive apparatus for a transmission changes the gears of the gear unit incorporated in the mission case 1 in the following manner. First, the selecting electric motor 9 is rotated in a predetermined direction to thereby swing and displace the swinging arm 13 in an up-down direction as viewed in FIG. 7. Then, the shift shaft 2 is axially displaced in a predetermined direction through the engagement piece 7 by the engagement convex portion 14 formed on the tip end portion of the swinging arm 13 to thereby perform a selecting operation. After the selecting operation is performed, the shift shaft 2 is rotated in a predetermined direction through the driving arm 15 by elongating and contracting the shifting actuator 16 so as to perform a shifting operation.

In the case of the aforementioned structure, the base end portion of the swinging arm 13 is connected to an end portion of the output shaft 12 through a connecting screw. However, the connecting screw, which connects the base end portion of the swinging arm 13 to the end portion of the output shaft 12, may be loosened by prolonged use thereof. When the this swinging arm 13 displaces the shift shaft 2 in an axial direction, relative displacement of the base end portion of this swinging arm 13 with respect to the end portion of the output shaft 12 occurs in a direction that is slightly opposite to the direction of rotation of this output shaft 12. This displacement is based on a reaction to the operation of displacing the shift shaft 2 in the axial direction, and caused by the minute gap between inner surfaces of a concave portion 23, which is formed in the end surface of the output shaft 12, and both side edges of the base end portion of the swinging arm 13, or by elastic deformation of both side parts of this concave portion 23.

In either case, when the base end portion of the swinging arm 13 displaces with respect to the end portion of the output shaft 12, the connecting screw, whose head portion abuts against the outer surface of this swinging arm 13, tends to displace in the same direction as that in which this swinging arm 13 displaces. In the case of the aforementioned structure, a screw hole, into which the connecting screw is screwed, is present in the central portion of the output shaft 12. Thus, the connecting screw tends to rotate with respect to the screw hole with the progress of the displacement. This tendency therein to rotate occurs in both directions as the swinging arm 13 performs reciprocating swinging motions. However, a force needed for rotating the connecting screw with respect to the screw hole in a loosening direction is smaller in magnitude than a force needed for rotating the connecting screw in a tightening direction. Therefore, there is the possibility that the connecting screw is gradually loosened with repetition of the reciprocating swinging motions of the swinging arm 13.

To prevent the connecting screw from being loosened due to the aforementioned causes, it is considered that an engagement portion for preventing the connecting screw from being loosened is provided between the head portion of this connecting screw and the swinging arm 13. Incidentally, the provision of the engagement portion specifically used for preventing the connecting screw from being loosened complicates processing and assembling operations and causes a cost rise.

### DISCLOSURE OF THE INVENTION

In view of such circumstances, a swinging actuator of the invention realizes a configuration enabled to prevent a screw, which is used for connecting and fixing the swinging actuator to an output shaft, from being loosened.

A swinging actuator of the invention has an output shaft rotatably supported by a support member, a driving source for rotate-driving the output shaft, and an output arm, whose base end portion is connected and fixed to an end surface of the output shaft. A portion to be driven is driven by the end portion of the output arm. This swinging actuator comprises a screw hole provided in a portion, which is positioned off the center of rotation of the output shaft, a through hole formed in the base end portion of the output arm, a connecting screw screwed into the screw hole in a state in which the connecting screw is inserted into the through hole, and an engagement portion provided between a part, which is positioned off the through hole and in the end portion of the output arm, and a part, which is off the screw hole and in the end surface of the output shaft.

In the case of the swinging actuator constituted as described above, the screw hole is provided in a portion that is off the center of rotation of the output shaft. Thus, a force in the direction of rotation thereof is hard to be applied to the connecting screw, which is screwed into the screw hole, as a swinging arm performs reciprocating swinging motions. Consequently, even in a case where an engagement portion specifically used for preventing the connecting screw from being loosened is not provided therein, the connecting screw is difficult to be loosened.

### BRIEF DESCRIPTION OF DRAWINGS

FIG. 1 is a front view shoring a selecting actuator according to an embodiment of the invention;

FIG. 2 is a plan view showing the selecting actuator according to the embodiment of the invention;

FIG. 3 is a rear view showing the selecting actuator according to the embodiment of the invention;

FIG. 4 is a side view showing the selecting actuator according to the embodiment of the invention;

FIG. 5 is a cross-sectional view taken along line A-A in FIG. 1;

FIG. 6 is a plan view showing an example of an electric drive apparatus for a transmission, which incorporates a swinging actuator;

FIG. 7 is a is a cross-sectional view taken along line B-B in FIG. 6;

FIG. 8 is a cross-sectional view taken along line C-C in FIG. 6; and

FIG. 9 is a schematic plan view showing an example of a shift pattern of a transmission.

### BEST MODE FOR CARRYING OUT THE INVENTION

An embodiment of a swinging actuator according to the invention is described in detail. Incidentally, the feature of this embodiment resides in that for the purpose of preventing the connecting screw, which is used for connecting the base end portion of the swinging arm to the end surface of the output shaft, from being loosened, a structure for connecting the base end portion of the swinging arm and the end surface of the output shaft is devised. Hereinafter, this is described in detail by referring to the accompanying drawings.

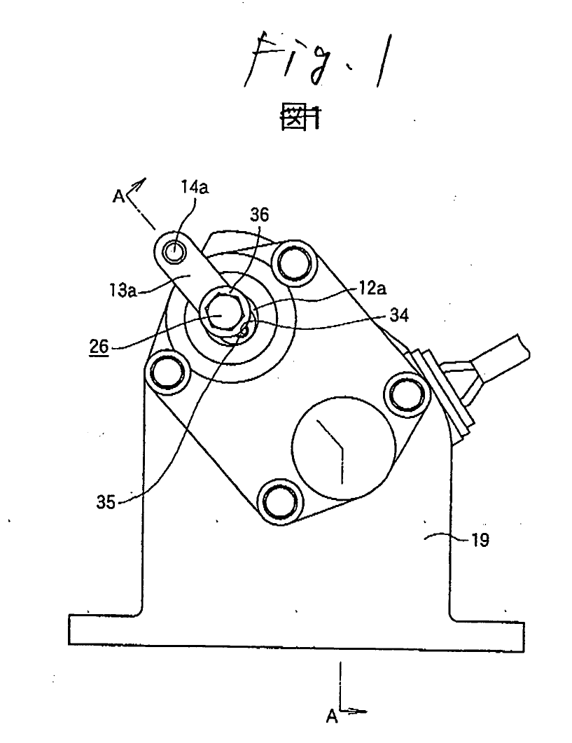

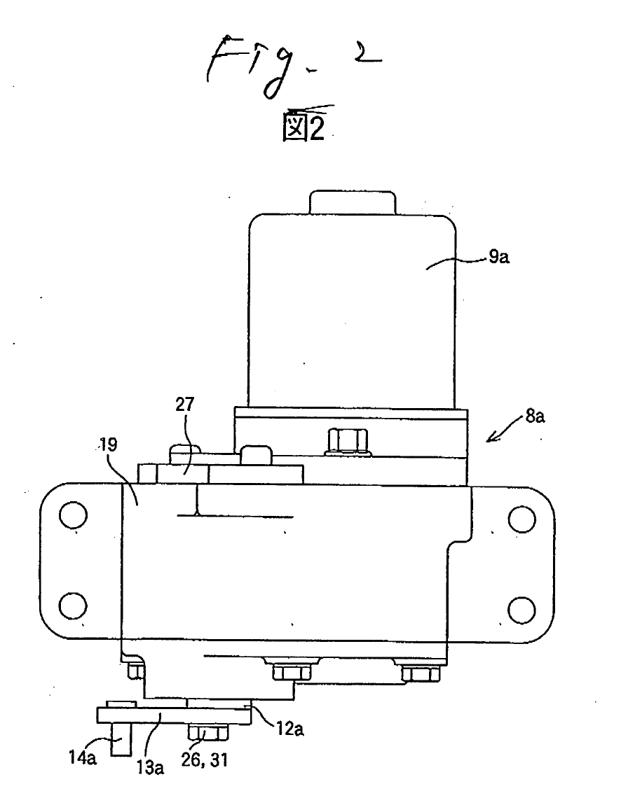

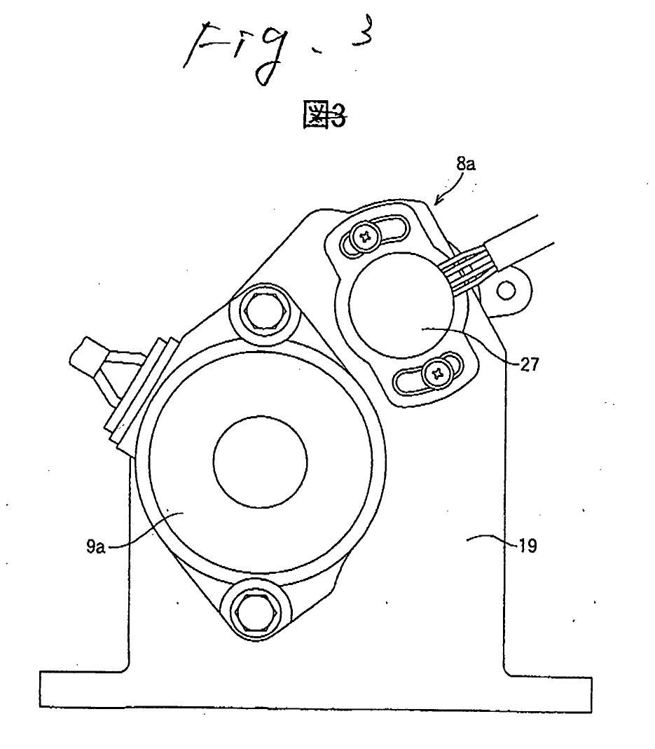

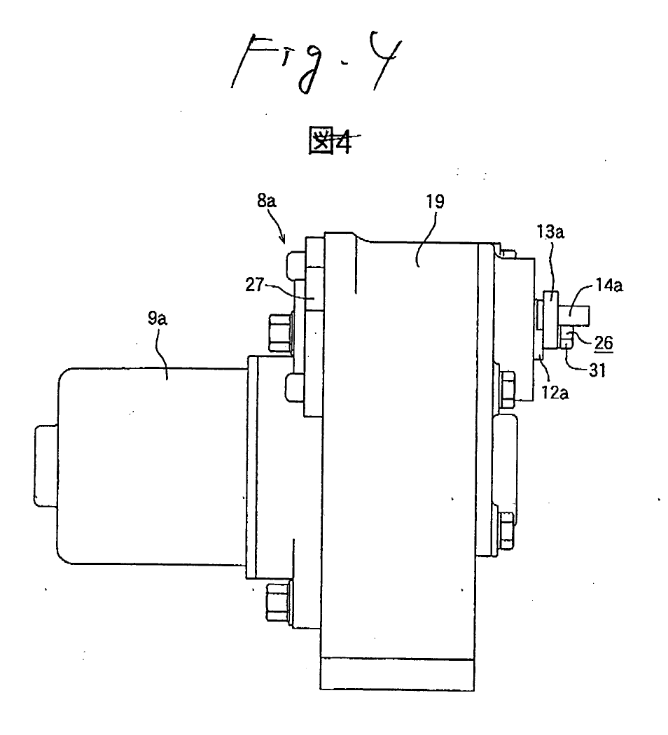

FIG. 1 is a front view showing a selecting actuator that is an embodiment of the swinging actuator according to the invention. FIG. 2 is a plan view showing the selecting actuator. FIG. 3 is a rear view showing the selecting actuator. FIG. 4 is a side view showing the selecting actuator. FIG. 5 is a cross-sectional view taken along line A-A in FIG. 1.

The selecting actuator according to this embodiment has a casing 19, a selecting electric motor 9a, which is a driving source assembled to the casing 19, and an output shaft 12a assembled to the casing 19. A transmission shaft 32 provided at an end of a rotation drive shaft 20 of the selecting electric motor 9a is fixedly provided on a pinion gear 21, and rotate-drives the coaxially disposed pinion gear 21. The pinion gear 21 meshes with a sector gear 22 fixedly provided on the outer peripheral surface of a middle portion of the output shaft 12a, so that the output shaft 12a can freely be rotate-driven in both directions by a predetermined angle. The transmission shaft 32 and the output shaft 12a are rotatably supported by pairs of ball bearings, respectively, in the casing 19 in such a way as to be parallel to each other. With the aforementioned configuration, the rotation of the rotation drive shaft 20 of the selecting electric motor 9a is transmitted to the output shaft 12a through the transmission shaft 32, the pinion gear 21, and the sector gear 22.

A screw hole 24 and a latch hole 33 are formed in the end surface (the right end surface as viewed in FIG. 5) of the output shaft 12a along an axial direction thereof. The screw hole 24 is a portion, which is off the center of rotation of the output shaft 12a, that is, a portion positioned closer to the outer peripheral surface of the output shaft 12a. On the other hand, the latch hole 33 is formed in a portion, which is a part of the end surface of the output shaft 12a and shifted from the screw hole 24 in an opposite direction with respect to the center of the end surface thereof. In other words, the center of the end surface thereof (the shaft center of the output shaft 12a) is present in a middle portion (which is not necessarily a central portion) of a straight line connecting the centers of the screw hole 24 and the latch hole 33.

On the other hand, a through hole 25 and a second through hole 34 are formed in the base end portion of the swinging arm 13a. The pitch between the through hole 25 and the second through hole 34 is equal to that between the screw hole 24 and the latch hole 33. Therefore, in a state in which the through hole 25 is aligned with the screw hole 24, the latch hole 33 is aligned with the second through hole 34. Further, the second through hole 34 is formed in a portion that is closer to the base end portion of the swinging arm 13a than the through hole 25.

The base end portion of the swinging arm 13a, in which the through hole 25 and the second through hole 34 are formed, is connected and fixed to the end surface of the output shaft 12a, which has the screw hole 24 and the latch hole 33. On connecting therebetween, first, in a state in which the latch hole 33 and the second through hole 34 are aligned with each other, a spring pin is put between both the holes 33 and 34. In this state, the spring pin 35 frictionally engages with the inner peripheral surface of one or each of both the holes 33 and 34. Subsequently, a connecting screw 26 inserted into the through hole 25 is screwed into the screw hole 24 and then tightened securely. In this state, a part of a separate washer 36, which is integrally formed with a head portion 31 of the connecting screw 26 or fitted onto the connecting screw 26, blocks a part of the second through hole 34. Thus, the slip-off of the spring pin 35 from between both the holes 33 and 34 is surely prevented. An ordinary pin having no elasticity may be used as a member put between both the holes 33 and 34.

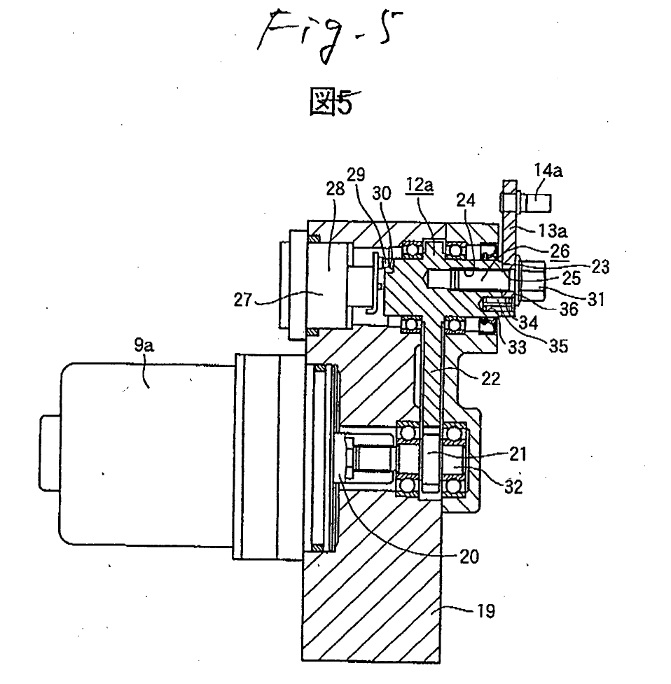

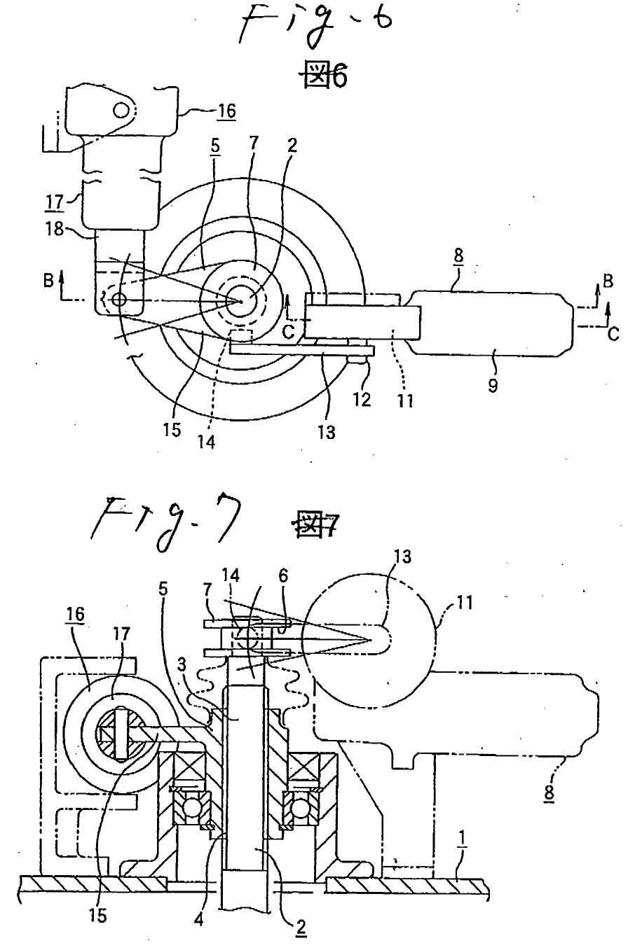

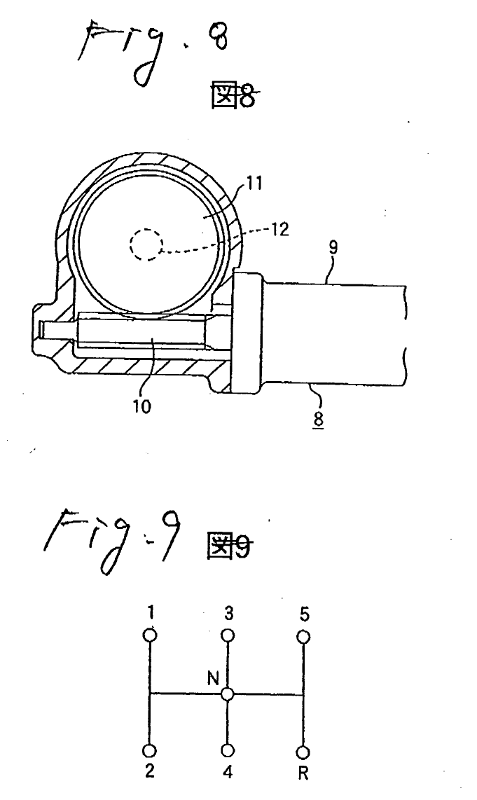

An engagement convex portion 14a is fitted and fixed to the end portion of the swinging arm 13a. The engagement convex portion 14a is constituted in such a manner as to be engageable with an engagement piece 7 (see FIGS. 6 and 7) fixed to the shift shaft 2.

In the casing 19, a displacement sensor 27 is supported coaxially with the output shaft 12a. An engagement projection 29, which is provided on a detection portion 28 of this displacement sensor 27 in such a way as to protrude therefrom, engages with an engagement concave portion 30 formed in the base end part of the detection portion 28. The displacement sensor 27 is constituted like a potentiometer, whose electric characteristics, such as values of resistance, change according to an angle of rotation of the detection portion 28, and enabled to detect a swinging angle of the output shaft 12a.

In a case where the shift shaft 2 shown in FIG. 6 is displaced in the axial direction by the selecting actuator 8a, the pinion gear 21 is rotated in a predetermined direction by driving the selecting electric motor 9a. The output shaft 12a is turned by the rotation of the pinion gear 21 through the sector gear 22. Thus, the swinging displacement of the swinging arm 13a is caused. Then, the engagement convex portion 14a provided at the end portion of this swinging arm 13a displaces the shift shaft 2 in the axial direction. Then, the displacement sensor 27 detects a displacement magnitude as an angle of rotation of the output shaft 12a.

As described above, according to this embodiment, in a state in which the base end portion of the swinging arm 13a is connected and fixed to the end surface of the output shaft 12a, torque is transmitted from the output shaft 12a to the swinging arm 13a. Regardless of minute swinging displacement of he base end portion of the swinging arm 13a with respect to the end portion of the output shaft 12a, which is caused by this transmission of torque, the connecting screw is prevented from being loosened.

That is, similarly, in this embodiment, the transmission of torque causes the minute relative displacement of the base end portion of the swinging arm 13a around the shaft center of the output shaft 12a with respect to the end portion of the output shaft 12a in a direction opposite to the direction of rotation of this output shaft 12a. In the case of this embodiment, the screw hole 24, into which the connecting screw 26 is screwed, is provided in the portion that is positioned off the shaft center of the output shaft 12a. Thus, with the minute displacement, a force in a direction of rotation of the connecting screw 26 is hard to be applied to the connecting screw 26 screwed into the screw hole 24. Consequently, even when an engagement portion specifically used for preventing the connecting screw from being loosened is not provided, the connecting screw 26 is hard to be loosened.

Incidentally, according to this embodiment, the position of the screw hole 24, in which the connecting screw 26 is screwed, is devised. Consequently, the connecting screw 26 is prevented from being loosened. The structure for preventing an occurrence of the relative rotation of the swinging arm 13a around the connecting screw 26 with respect to the output shaft 12a is not limited to the spring pin 35. Various structures, which have hither to be known, may be employed. Incidentally, in the case of the structure implemented by the engagement between a pin and a hole can reduce the cost, because of easiness of processing each of the parts.

Although the embodiment according to the invention has been described in the foregoing description, it is apparent to those skilled in the art that various alterations and modifications may be made without departing from the spirit and scope of the invention.

The present application is based on the Japanese Patent Application (No. 2002-031248), filed Feb. 7, 2000, the contents of which are incorporated by reference.

### Industrial Applicability

A highly reliable and low cost swinging actuator can be obtained.

1. A swinging actuator having an output shaft rotatably supported by a support member, a driving source for rotate-driving said output shaft, and an output arm, whose base end portion is connected and fixed to an end surface of said output shaft, a portion to be driven being driven by said end portion of said output arm, said swinging actuator, characterized by comprising:
a screw hole provided in a portion, which is positioned off a center of rotation of said output shaft;
a through hole formed in said base end portion of said output arm;
a connecting screw screwed into said screw hole in a state in which said connecting screw is inserted into said through hole; and
an engagement portion provided between a part, which is positioned off said through hole and in said end portion of said output arm, and a part, which is off said screw hole and in said end surface of said output shaft.

2. The swinging actuator according to claim 1, wherein a shaft center of said output shaft is positioned between said connecting screw and said engagement portion.
